(19) United States
(12) Patent Application Publication
(10) Pub. No.: US 2014/0361896 A1
(43) Pub. Date: Dec. 11, 2014

(54) Intrusion Detection System and Method thereof

(71) Applicant: Keith Alan Sibley, Florissant, MO (US)

(72) Inventor: Keith Alan Sibley, Florissant, MO (US)

(21) Appl. No.: 13/911,054

(22) Filed: Jun. 5, 2013

(51) Int. Cl. G08B 13/08; G08B 13/04

(52) U.S. Cl. CPC G08B 13/08; G08B 13/04
USPC 340/546

(57) ABSTRACT

An intrusion detection system and method for sliding windows and doors is disclosed. The present invention is installed in the casing of a sliding window or door and allows for the selectively positional opening and closing allowing for fresh air ventilation and initiates an alarm condition if the window or door is opened far enough to allow for the admittance of an intruder. The present invention incorporates the use of ultrasonic ranging to continuously measure the distance from the casing of a window or door to the backside of the inside member of the same window or door. The present invention will also incorporate the use of a magnetic reed switch to indicate an alarm condition if the outer member of a double hung or double sliding window or door is moved.

### FIELD OF THE INVENTION

This invention relates to a window and door mounted alarm system and method for detecting the breaching of security of an installation, and more particularly to an alarm system and method, particularly adapted to movable doors and windows that move in either a vertical or horizontal sliding motion, to provide security while allowing the window or door to be partially opened to allow for fresh air ventilation, without the compromising of protection, and will indicate an alarm or trouble condition either when the window or door is opened beyond a predetermined distance, when the moveable member of the window or door is removed, or when the present invention itself is removed from the window casing.

### BACKGROUND OF THE INVENTION

The present day need for security systems in an ever increasing one with the statistics relating to forcible entry, burglary, and the likes continually rising. Frequently and from time to time the criminals make their forced entry through sliding windows and doors. As a result a multiplicity of systems and devices designed to sense unwanted intrusion have appeared on the marketplace.

In addition to these rising crime rates the typical alarm user is also faced with rising fuel costs along with environmental and energy conservation concerns and the precaution of keeping a sliding door or window closed and locked can be a hindrance to both of these concerns.

One of the problems with most current systems is when it comes to sliding doors and windows. They are generally protected by a magnetically responsive switch, a button type switch, or the likes. Where as these are effective in deterring forced entry they are very limited, for example the window or door must be completely closed in order to provide protection, meaning that the window or door cannot be left open a small bit to allow for ventilation and fresh air.

Allowing for ventilation and fresh air in an enclosed building or structure enables the ability of taking advantage of the environmental conditions that exist outside of the building or structure therefore reducing the use of the building or structures interior climate control or HVAC systems, thereby reducing energy use, which saves money, and reducing the environmental impact of these systems.

One of the earliest methods to allow for this fresh air control was to wire, in parallel, two magnetically responsive switches and to place one magnet on the sliding member of the window or door this allowed for two protected positions for the window or door. If the window was opened an alarm was activated. However this method was not very effective for the fact that it could be easily bypassed which allowed undetected access to the building or the structure that was being protected, did not allow the window or door being protected, once armed, to be moved without initiating an alarm condition, and was not selectively positional.

Other better and more sophisticated methods have come up over the years that allow for the advantage of fresh air and some which eliminate this restriction of movement while the alarm system or device is set.

One such method includes using the screen as the alarm device this involves weaving a wire onto or through the screen mesh and connecting this wire to a magnetic responsive switch or plug device. Thus, the removal of the screen, or the cutting or breaking of any of the wires in the mesh, will activate an alarm. Various examples of this method can be found in U.S. Pat. No. 3,051,935 (Willson), U.S. Pat. No. 4,814,750 (Abramson), U.S. Pat. No. 4,839,632 (Zahn, Jr, et al.), and U.S. Pat. No. 5,103,208 (Riordan). This method, however, creates new problems in as that they are limited in the size of the window that they fit, therefore, more than one size may be needed, they are place on the outside of the window being protected, thereby, enabling a would be intruder easy access to their components, increasing the chances of bypassing, and also exposing any electrical connections and components to the outside environmental elements which can cause corrosion and other problems, and that they are not suited for sliding doors which also have a sliding screen door member.

Another method that has been introduced over the years can be found in U.S. Pat. No. 4,896,139 (Eldridge), U.S. Pat. No. 4,888,578 (Conemac), and U.S. Pat. No. 6,778,086 (Morron, Tedesco).

These patents refer to an expandable staff type of device which is a combination locking device and alarm device. Some of which are selectively positional meaning that they can allow the window to open or close freely within the selected range. Whereas they can be effective in preventing intrusion they created new problems. For one they are ascetically displeasing, two they will slow egress through the protected window or door due to fire or any other emergency that may arise, and lastly they again are limited in the size of the window or door that they fit, therefore, more than one size may be needed.

Another type of locking alarm device can be found in U.S. Pat. No. 5,734,324 (William). This patent refers to a circular type device that is affixed to the stationary or outer most member of the window with a suction cup. It is positioned at a point which is the furthest the window in allowed to be opened. When the window is opened to the point at which the frame of the moveable member comes in contact with the device and an alarm will sound and the window will not be allowed to open any further. Whereas, this type of device can work on any size window it is again ascetically displeasing and will again slow any emergency egress that may arise. In addition none of these actually measure the distance that the window or door is open.

### SUMMARY OF THE INVENTION

Accordingly, it is one object of the present invention is to create a system and method of protection, for closures having sliding members such as sliding windows and doors and the like, that places itself and functions in a manner that allows for the closure to be partially open for fresh air and ventilation within a structure or building and that eliminates movement restriction along with the ability to be bypassed, directed to the provision of an alarm system for structures that have doors and/or windows that open and close in either a vertical or horizontal sliding motion.

It is another object of the present invention to provide a system and method of protection that has the ability to work on almost any size and configuration of sliding window or door.

It is a further object of the present invention to provide a system and method of protection which is also responsive to either the removal of either of the members of the window or door or to the removal or tampering of the present invention itself.

It is still a further object of the present invention to provide a system and method of protection that will not interfere with or prohibit in any way with any emergency egress or ingress through the protected window or door that may arise.

It is yet still a further object of the present invention to provide a system and method of protection that will be minimal in its impact on the ascetics of the protected window or door.

It is yet still a further object of the present invention to provide a system and method of protection that will be minimal in its impact to cleaning and maintenance of the protected window or door.

It is yet still a further object of the present invention to provide a system and method which measures the actual distance in which the window or door is open.

Additional objects, features, and advantages of the invention will be set forth here in part by the detailed description which follows and in part will become obvious from the description, or may be learned by practice of the invention.

### BRIEF DESCRIPTION OF THE DRAWINGS

The accompanying drawings, which are incorporated in and constitute a part of this specification, illustrate one embodiment of the present invention, together with the description serve to illustrate the principles of the invention.

FIG. 1a. Is a drawing of a typical sliding window configuration and its major components.

FIG. 1b. Is an exploded view drawing of the typical sliding window and its major components.

FIG. 2. A close-up isometric view of the present invention with sensor.

FIG. 3. Shows the preferred placement of the present invention for the protection of sash style and double hung style windows

FIG. 4. Shows the preferred placement of the present invention for the protection of slider style and double slider style windows

FIG. 5. Shows the preferred placement of the present invention for the protection of a sliding door.

FIG. 6. Drawing of use of present invention and magnet for the protection of double hung and double slider styles of windows and doors.

FIG. 7. An electrical block schematic in accordance with one embodiment of the present invention.

### DETAILED DESCRIPTION OF THE PREFERRED EMBODIMENT

The following detailed description is of one embodiment of the present invention. The description is not intended in a limiting sense and is made solely for the purpose of illustrating the general principles of the present invention. The various advantages and features of the present invention may be more readily understood with reference to the following detailed description taken in conjunction with the accompanying drawings.

Reference will now be made in detail to the present embodiment of the present invention, an example of which is illustrated in the accompanying drawings. In the drawings, like reference numbers have been used throughout to designate identical elements.

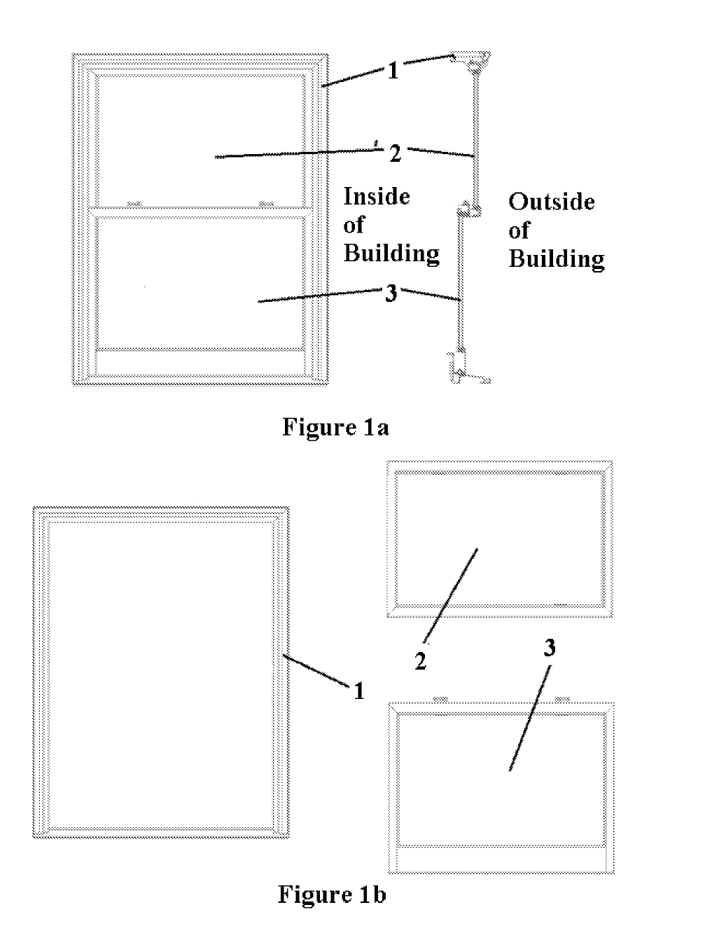

To better understand the principals of the present invention the general components and principles of operation of a sliding window or door must be understood. For use of demonstrating and explaining the components and principals of a sliding window or door FIG. 1a and FIG. 1b show a typical sliding window and its major components, an assembly view and an exploded view respectively. Whereas, these drawings are specifically of a sash type window the major components and principles of operation of the window, for use of the present invention, are generally the same for any type of sliding window or door.

As can be seen in FIG. 1a and FIG. 1b there are three major components to the common sliding window or door Item 1 which is the outer frame, Item 2 which is the outer member and Item 3 which is the inner member. Referring to Item 1 the outer frame of the window or door which serves to encase or hold the members of the window or door. It has one or more guides or tracks built into its design which allows for the movement of any of the moveable members and is generally constructed of wood, vinyl, or aluminum. Items 2 and 3 are the members or panes themselves, panes of glass encased by their own separate frame constructed of a like material to that of the window or door outer frame. Items 2 and 3 are offset from each other within the outer frame to allow for the opening and closing of the window or door. The outer member, Item 2, is placed within the outer frame toward the outside of the building or structure and the inner member, Item 3, is placed within the outer frame toward the inside of the building or structure. Generally the inner member is movable and the outer member is either moveable or non-moveable.

The present invention depicted as Item 5 in the drawings shall consist of the required circuitry encased within a housing or case constructed of plastic or other suitable material,

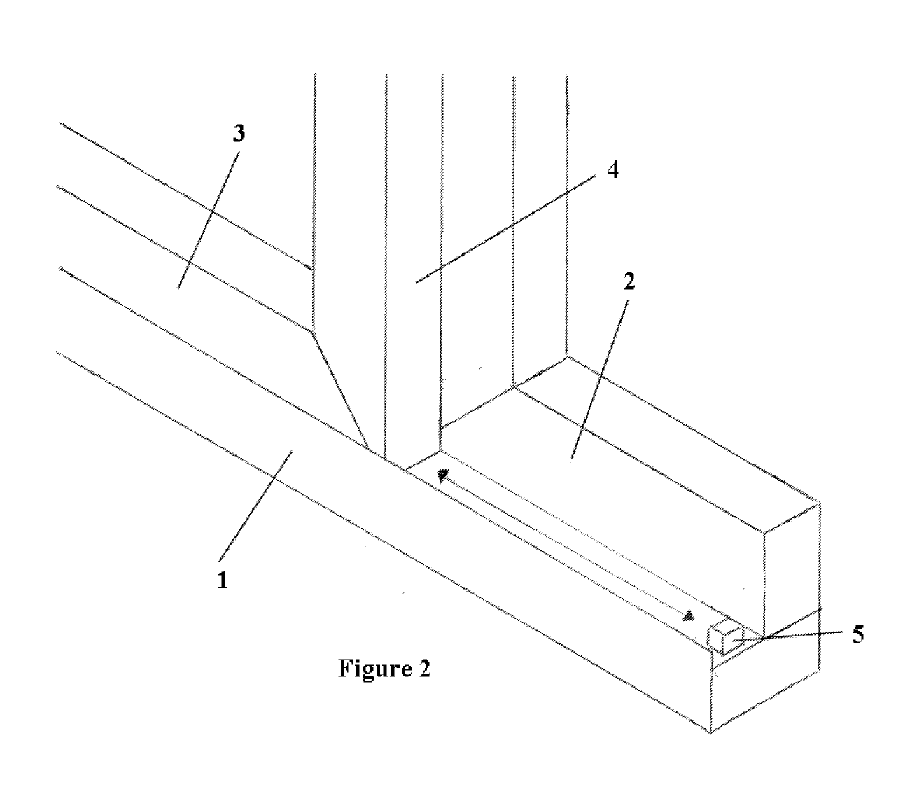

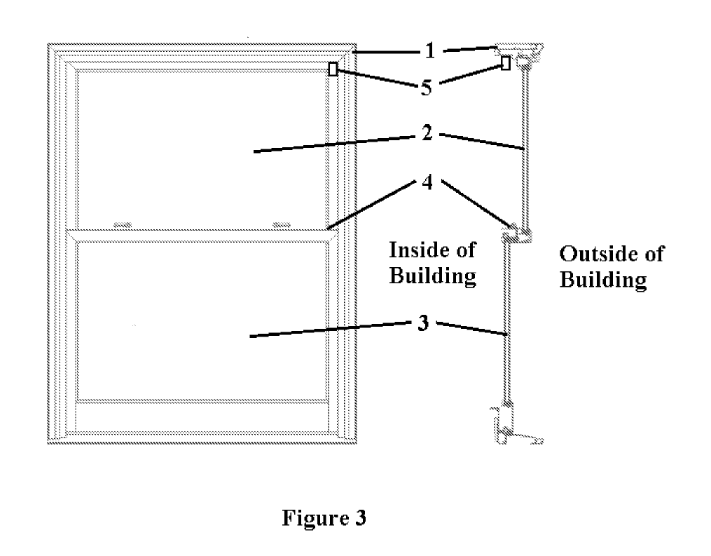

As seen in FIGS. 2 the present invention, Item 5, shall be placed in line and parallel with the guide or track of the outer frame, Item 1, with the direction of functionality aimed toward the perpendicular facing edge of the frame for the inner member, Item 3. This facing edge, depicted as Item 4 in the drawings, shall serve as the reading edge for the present invention. In this fashion it will read the distance between the present invention, Item 5, and this reading edge, Item 4, meaning that as the window or door is opened this distance becomes smaller and as the window or door is closed it becomes larger. The preferred placement of the present invention for use with some of the various styles of windows and doors can be found in FIGS. 3, 4, and 5.

As seen in FIG. 3 for sash style windows, vertically sliding windows where the inner member, Item 3, the only moveable member and for double hung style windows, vertically sliding where both the inner member, Item 3 and the outer member, Item 2, are movable, the present invention shall be placed at the upper most part of the outer frame, Item 1, reading the distance shown by the arrows which also shows the travel direction of the moveable members movement. Placement can be anywhere along this upper part of the casing, either the extreme right or left hand corner, as shown by Item 5, is preferred.

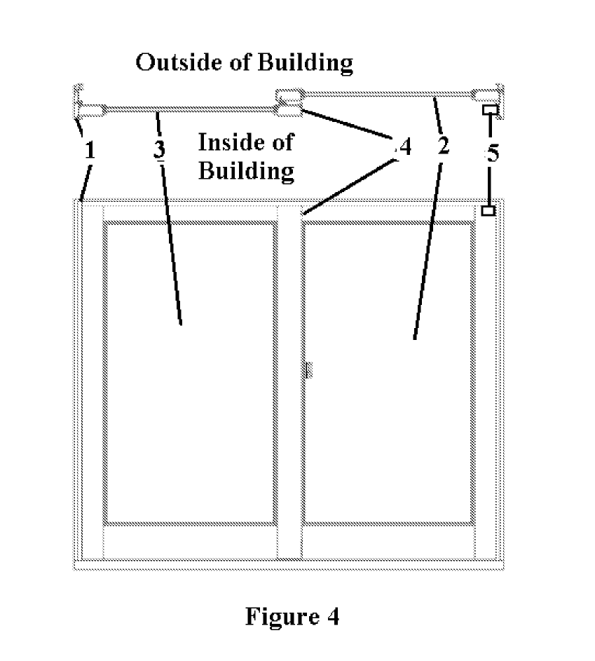

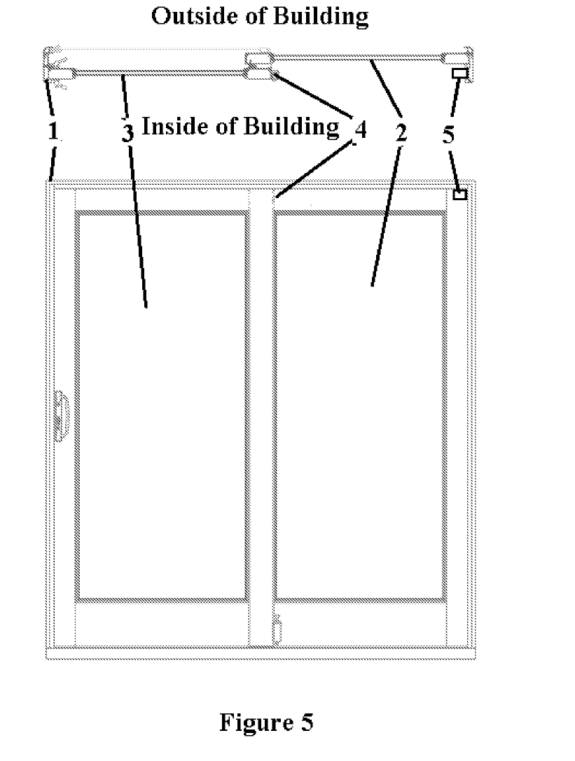

FIGS. 4 and 5 show the placement of the present invention for slider style windows and doors, horizontally sliding windows and doors where the inner member, Item 3, is the is the only moveable member, and for double slider style windows and doors, horizontally sliding windows and doors where both the inner member, Item 3, and the outer member, Item 2, are movable, the present invention shall be placed at the opposite side of the casing, Item 1, from the inner member, Item 3 preferably in the upper corner of the casing, as shown by Item 5, and again reading the distance shown by the arrows which is again also the travel direction of the moveable members.

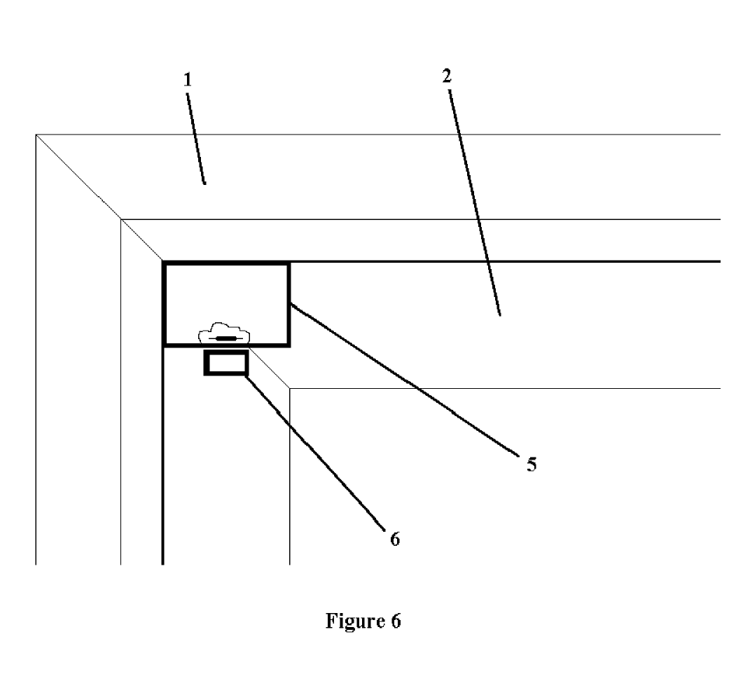

As seen in FIG. 6 when both the inner members and the outer members of the window or door are moveable, as in the case of double hung and double slider windows and doors, a magnet, Item 6, shall be affixed to the outer member of the window or door, Item 2, and within the proximity of a magnetically responsive reed switch which shall be incorporated within the circuitry and housing of the present invention, Item 5, as seen through the cut out.

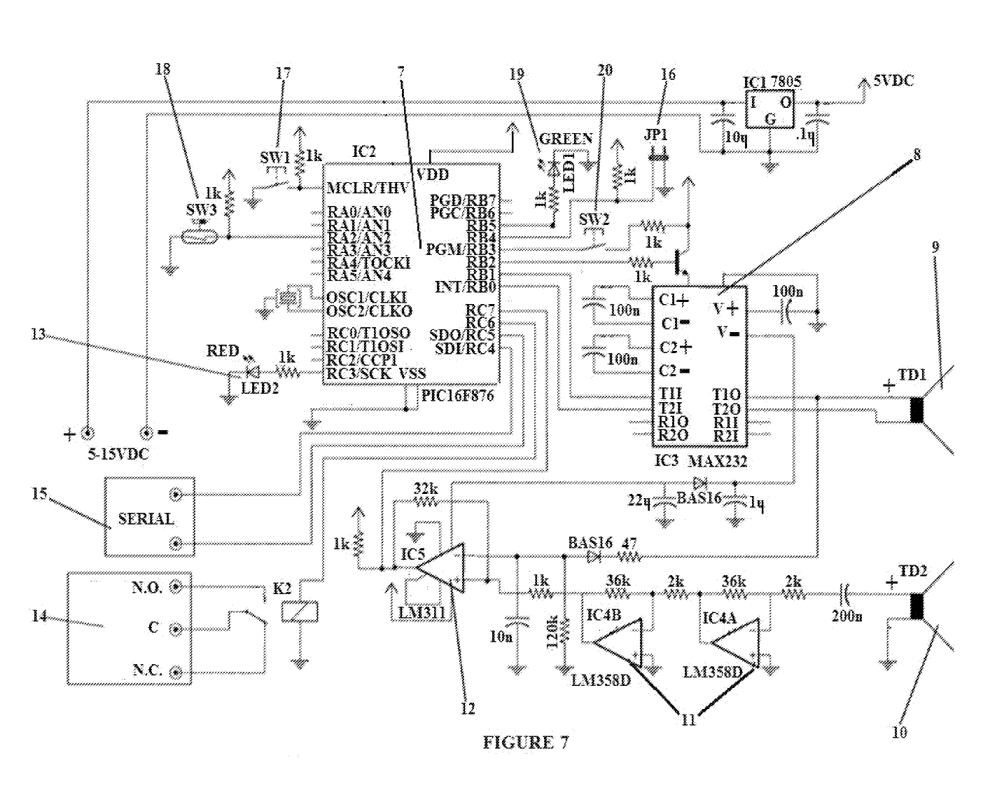

Referring now to FIG. 7, this is a block schematic diagram of a preferred embodiment of the present invention.

The circuit shown in FIG. 7 is low in power consumptions and can operate with an input voltage range of 5-15 volts; this is a voltage range that can be easily obtained through the use of common batteries, solar cells, auxiliary power supplies, and alarm systems themselves or any combination of the above. This circuit consists of the four sub-circuits shown the control, transmit, receive, and output circuits.

The control circuit which is responsible for all of the control, timing, response, and output functions of the present invention and in this example is implemented via a microcontroller or similar digital logic device and associated components.

The transmit circuit transmits a frequency burst created by the controller and consists of a signal amplifying means, a standard 40 kHz ultrasonic transducer, and associated components.

The receive circuit detects and validates the returning echo of the transmitted burst and of a standard 40 kHz ultrasonic transducer, a signal amplifying means, a signal comparing means, and associated components.

The output circuit is the actual alarm indication or signaling means of the present invention. This alarm or trouble signal may be any combination of the following an audible signal, a visual signal, an indicator, a relay controlled set of contacts, a means of serial communication and a means of wireless communication.

When the present invention is embodied with a relay controlled set of contacts the contacts may be used as a means to signal or notify an onsite central alarm system or panel and/or a as means to activate an external device, such as a siren or strobe.

When the present invention is embodied with connections for serial communication, wired or wireless, the data that is transferred may be either generic data in the form of an alarm or trouble code or may be the actual value that corresponds to the how far the window or door is opened.

In this example embodiment the present invention has two modes of operation a setup mode, which is used during the initial installation and setup to determine and store if the outer member of the window or door is movable, to determine and store a time value which corresponds to the size of the window and door, and to determine and store a time value which corresponds to the desired maximum open distance of the window or door, and protection mode, which is the normal operating mode, this mode is determined by JP1 (jumper), Item 16.

With JP1, Item 16, shorted and SW1 (switch), Item 17, momentarily depressed the present example of the present invention will begin operation in setup mode. Upon initial entry of setup mode it is determined and stored within the EEPROM (electrically erased programmable read only memory) of the PIC, Item 7, whether or not the magnetically responsive switch, Item 18, is activated by the proximity of the magnet, Item 6, of FIG. 6 completion of this is indicated by the illumination of indicators LED2, Item 13, and LED1, Item 19. With the window or door in the fully closed position and SW2, Item 20, momentarily depressed LED1, Item 19, will shut off and a short ultrasonic burst will be generated and transmitted. The return of the echo is then timed and this value, which corresponds to the size of the window or door, is stored in the EEPROM of the PIC, Item 7, once stored LED1, Item 16, will again illuminate indicating completion. With SW2, Item 20, momentary depressed again, this time the window or door is either again in the fully closed position or open to the desired maximum allowable open distance, the previous processes of transmitting a pulse and receiving an echo will be repeated, this time the returned time value corresponds to the desired maximum allowable open distance. If the window or door is again in the fully closed position, meaning the time value returned is equal to, within a few microseconds, the time value previously stored for the size of the window or door then 888 microseconds, which is equivalent to approximately six inches, will be subtracted from this previously stored value for the size of the window or door and the result stored within the EEPROM of the PIC, Item 7. If the window or door is in an open position, meaning the time value returned is less than the time value previously stored for the size of the window or door, this new time value will be stored within the EEPROM of the PIC, Item 7, however, if this new time value is more than 888 microseconds smaller than the time value previously stored for the size of the window or door, meaning that the window or door is opened more than approximately six inches, then once again 888 microseconds will be subtracted from this previously stored value for the size of the window or door and the result stored within the EEPROM, meaning that in this example of the present invention the preferred maximum allowable open will be limited to a maximum of approximately six inches. LED1, Item 19, will again illuminate to signal completion of setup.

With JP1, Item 16, open and SW1, Item 17, momentarily depressed the present example will operate in protection mode indicated by a flashing illumination of LED1, Item 19. Upon initial entry of protection mode the present example will first determine, by use of the data stored in the EEPROM of the PIC, Item 7, during setup, whether or not SW3, Item 18, needs to be checked or not. If the data stored indicates that SW3, Item 18, was activated by the proximity of a magnet during setup then it shall be checked if it was not activated, meaning no magnet was present then it shall not be checked.

While in protection mode the present invention operates in a continuous loop in which the reed switch SW3, Item 18, is checked, if necessary, and if faulted, meaning the outer member of the window or door has been opened or removed or that present invention itself has been removed, the present invention will signal an alarm or trouble condition, the tamper switch SW2, Item 20, is checked and if faulted, meaning that the housing of the present invention has been opened, the present invention will signal an alarm or trouble condition, and an ultrasonic burst is generated and transmitted and the returning of the echo is timed and this new time value is compared to the times values stored in the EEPROM of the PIC, Item 7. However, if no echo is received within the time value stored for the size of the window or door plus an additional ten microseconds the present example will react as if an echo has been received and use this value, the time value stored for the size of the time window plus 10 microseconds, shall be used as the new time value for comparison.

If this new time value is either equal to, within a few microseconds, or within the limits set by the time values stored within the EEPROM of the PIC, Item 7, the preceding process repeats itself, however, if this new time value is greater than, within a few microseconds, the time value stored which corresponds to the size of the window or door, meaning the movable member of the window or door and/or the present invention itself have been removed from the casing, or if this new time value is less than, within a few microseconds, the stored time value which corresponds to the desired maximum open distance, meaning that the window or door has been opened beyond the allowable limit, the present invention will signal an alarm or trouble condition.

Although an exemplary embodiment of the present invention has been shown and described, it will be apparent to those having ordinary skill in the art that a number of changes, modifications, or alterations to the present invention described herein may be made, none of which depart from the spirit or principles of the present invention. All such changes, modifications, and alterations should therefore be seen as being within the scope of the present invention.

It should be appreciated that the present invention provides a substantial advance in alarm systems and methods for sliding doors and windows providing all of the herein described objects and advantages without incurring any relative disadvantages.

1. An alarm system and method for use with windows and doors that open and close in either a vertical or horizontal sliding motion comprised of one or more ultrasonic transducers, used for ultrasonic ranging, an electrically powered signal creating means and associated electronic circuitry housed within a housing comprised of plastic or other suitable material to allow for selectively positional opening and closing of the window or door upon which installed.

2. An alarm system and method according to claim 1 that is responsive to the opening of the housing of the present invention.

3. An alarm system and method according to claim 1 that is responsive to the removal of the present invention from the window or door casing.

4. An alarm system and method according to claim 1 that is responsive to the removal of the inner member of the window or door from the window or door casing.

5. An alarm system and method according to claim 1 that is responsive to the movement of or the removal of the outer member, if moveable, of the window or door within or from, respectively, the window or door casing.

6. An alarm system and method according to claim 1 which measures the position in which the window or door is actually opened to.

7. An alarm system and method according to claim 1 which measures a reference distance of the window or door in its fully closed position

8. An alarm system and method according to claim 7 whereas reference distance is retained or stored on a permanent basis.

9. An alarm system and method according to claim 1 wherein the electrically powered signal creating means comprises a means of sending a signal to a remote alarm device.

10. An alarm system and method according to claim 9 where signal creating means is serial communications, wired or wireless, with remote alarm device transmitted data may be in the form of the actual distance in which window or door is opened.

11. An alarm system and method according to claim 10 where signal creating means is wireless

12. An alarm system and method according to claim 1 further comprising a glass break detection device associated with or incorporated into said alarm system and method.
